(19) United States
(12) Patent Application Publication
(10) Pub. No.: US 2025/0216562 A1
(43) Pub. Date: Jul. 3, 2025

(54) EMISSION TOMOGRAPHY WITH GENERALIZED TIME ENCODED APERTURE IMAGING

(71) Applicant: Siemens Medical Solutions USA, Inc., Malvern, PA (US)

(72) Inventors: Alexander Hans Vija, Evanston, IL (US); Francesc dAssis Massanes Basi, Chicago, IL (US)

(21) Appl. No.: 18/851,143

(22) PCT Filed: Jun. 14, 2022
(86) PCT No.: PCT/US2022/072913

§ 371 Date: Sep. 27, 2024

(51) Int. Cl. G01T 1/29

(52) U.S. Cl. CPC G01T 1/295; G01T 1/2985

(57) ABSTRACT

For emission tomography, a greater number of emissions are detected. To detect a greater number of emissions and provide better resolution than provided by a parallel hole collimator, the collimator is replaced by an attenuation object with exterior and interior edges. Rather than enforcing directionality, larger holes with different shapes may be used to allow a greater number of emissions to be detected. By moving the attenuation object, the differences in the shadows on the sensor may be used as a time-encoded aperture to reconstruct the source of emissions with greater resolution and sensitivity than where a fixed parallel hole collimator is used.

### BACKGROUND

The present embodiments relate to emission tomography, such as single photon emission computed tomography (SPECT), photon emission tomography (PET), or another type of imaging using a gamma camera. High efficiency tomographic imaging of gamma rays emitted from radioisotopes is in general done from discrete spectra from about above 50 keV to <511 keV using physical collimators. These collimators only allow gamma rays to enter the sensor within a specified direction (i.e., parallel hole collimators) to create the projection image (i.e., image detected by the gamma camera). This process has a trade-off between high direction accuracy from the collimator versus count sensitivity. The small, directional holes of the collimator block many rays. This low sensitivity results in noisy data, which makes the inverse problem, i.e., tomography, hard, resulting in artifacts. For tomographic reconstruction, the high directional accuracy is enforced by the collimator at high cost to sensitivity.

Medical emission tomography is used for various specific categories of tasks: 1. to detect lesions (“detection tasks”), whereby a lesion is abnormal uptake either too high or too low as compared what is expected, based on the anatomy, physiology, and administered radiopharmaceutical, and 2. to characterize the lesion or uptake pattern by descriptive statistics, such as mean uptake density. In some cases, the ability to spatially resolve is important (spatial resolution), in other cases it is important to resolve a signal in a noisy background, i.e., contrast resolution, and yet in other case as uptake changes in time (“temporal resolution”). In general, a statistical based criterion is used that separates signal from noise with a certain confidence level. Fundamental trade-off between information of presence (“sensitivity”) verses direction (“resolution”) remains.

The fundamental trade-off can be influenced by imposing or exploiting ancillary physical conditions of the specific image formation. Contrast and attenuation patterns may be used as a source of information, derived from exploiting physical conditions of the specific image formation. Edge encoding has been shown. Time dependent changeable patterns, such as super-resolved time multiplexing methods, have been considered. Compressed sensing is used. Further increase in sensitivity may result in better emission tomography imaging for a specific clinical task, if the use of the additional information can more than compensate for the loss of directional information.

### SUMMARY

By way of introduction, the preferred embodiments described below include methods, systems, and sensors for emission tomography. To detect a greater number of emissions and/or provide better resolution than provided by a parallel hole collimator, the collimator is replaced by an attenuation object with exterior and interior edges. Rather than enforcing directionality, larger holes with different shapes may be used to allow a greater number of emissions to be detected. By moving the attenuation object, the differences in the shadows on the sensor may be used as a time-encoded aperture to reconstruct the source of emissions with greater resolution and sensitivity than where a fixed parallel hole collimator is used. The directional information desired for the specific task is acquired based on the moving shadows.

In a first aspect, an emission tomography system is provided. A sensor is configured to detect time, location, and energy of gamma rays. A movable attenuator has one or more interior through-holes. A drive is configured to move the movable attenuator. An image processor is configured to reconstruct a spatial distribution of emissions detected by the sensor with the movable attenuator in different positions due to movement by the drive. The movable attenuator is between a source of the emissions and the sensor such that a moving shadow of the through-holes is cast on the sensor.

In one embodiment, the sensor is a planar gamma camera. As a further example, the planar gamma camera connects with a gantry configured to place the planar gamma camera at different locations relative to the source for detection of the emissions.

The movable attenuator has various embodiments. According to one embodiment, the movable attenuator is a lead or tungsten object. As a further embodiment, the movable attenuator is movable by translation and/or rotation in three dimensions. In another embodiment, the through-holes are slits. In other embodiments, the through-holes have different sizes, shapes, and/or angles of holes.

As a further embodiment, the movable attenuator is a rotatable cylinder where the source or sensor is positionable within the rotatable cylinder. The drive is configured to rotate the rotatable cylinder. The movable attenuator may have various shapes, such as plate.

In one embodiment, the drive is configured to rock the movable attenuator and/or to wobble the movable attenuator around a normal to the movable attenuator. Other movements may be used, such as based on the imaging application.

In an embodiment, the image processor is configured to form projections from the emissions and the reconstruction of the spatial distribution is from the projections. As an example, the projections are virtual parallel hole collimator projections, and the reconstruction is an iterative reconstruction with the virtual parallel hole collimator projections in forward and back projection.

In a second aspect, a method is provided for SPECT. An attenuating object with interior edges is moved between a patient and a sensor. The interior edges with the moving form a time-encoded aperture on the sensor. The sensor detects emissions from the patient passing through the attenuating object with different shadows on the sensor due to the time-encoded aperture. A representation of the patient is reconstructed from the detected emissions using the time-encoded aperture.

In one embodiment, the attenuating object is rotated and/or translated in three dimensions. The shadows are different due to location on the sensor and/or rotation of the attenuating object.

As another embodiment, the interior edges form holes having different shapes, sizes, and/or angles, resulting in corresponding shadows.

In another embodiment, holes in the attenuating object form the edges. The attenuating object is moved in three dimensions so that a shape and/or size of holes in the shadows is different at different times.

In yet another embodiment, the reconstruction is from edge response of the shadows. As another reconstruction embodiment, the reconstruction includes constructing projections at different viewing angles relative to the patient from the detected emissions and based on the time-encoded aperture and reconstructing from the projections.

In a third aspect, an emission tomography system is provided. A ray-blocker has interior edges forming holes through the ray-blocker. A sensor is configured to detect rays passing through the holes with the ray-blocker at different locations relative to the sensor. The different locations form a time-encoded aperture for the sensor. An image processor is configured to form virtual projections from different view from emissions detected by the sensor using the time-encoded aperture and to reconstruct a representation of a patient from the virtual projections.

In a further embodiment, the holes have different sizes, shapes, and/or angles.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is one embodiment of an emission tomography system with a movable attenuator;

FIG. 2 illustrates different shadows on a sensor due to moving an attenuator with slits;

FIG. 3 illustrates an example attenuator with concentric slit holes;

FIG. 4 illustrates an example attenuator with non-concentric slit holes;

FIG. 5 illustrates an example of wobbling an attenuator to move in three dimensions;

FIG. 6 illustrates an example attenuator with off-set holes;

FIG. 7 illustrates an example movement of tilting an attenuator;

FIG. 8 illustrates one embodiment of the attenuator as a cylinder or hollow form;

FIG. 9 illustrates an example of use of edge response to isolate a source location;

FIG. 10 is an example graph showing a virtual point spread function for edge response; and

FIG. 11 is a flow chart diagram of an example embodiment of a method for emission tomography imaging using edge response.

### DETAILED DESCRIPTION OF THE DRAWINGS AND PRESENTLY PREFERRED EMBODIMENTS

Any non-local pattern of the coded aperture or physical collimator can be used to probe spatial frequencies. In classical SPECT imaging, a regular degenerate pattern (e.g., parallel holes) is used to create a non-local PSF across the field of view (FOV). The result is strict quality control on collimator and sensor uniformity, choosing apertures that are smaller in size than the intrinsic resolution to create degenerate response to maximize signal-to-noise ratio (SNR) without adding computational burden. This approach can be abandoned where a very local response and time-encoded and varying collimation are used.

An emission tomography system uses a restored virtual system resolution from generalized, time-encoded aperture imaging data for imaging of discrete or continuous gamma ray spectrum. The concept of time-encoded coded aperture is generalized to enable edge-based super-resolution. The edge resolution given a known attenuation object is used to create a data set that allows for super resolution, distance estimation, and/or tomographic information. The attenuation object provides an encoding mask.

Using the edge resolution information and positive semi-definiteness of the problem, emission tomography image formation is provided using movement of a three-dimensional attenuator with sharp edges. Directionality is extracted from a non-local pattern of the point-spread function (PSF) across the field of view (FOV) from the encoded time varying aperture pattern based on the semi-positive definite data.

Using the edge response from the time-encoded aperture to isolate directionality and holes in the attenuating object to increase the number of detected emissions with a greater length of edge opens up the image formation space. Directionality information is more efficiently extracted than with fixed parallel hole collimators. For near field tomography, the shape and movement of the attenuating aperture is designed for the application (e.g., specific moving pattern of the attenuating apertures object based on the purpose of the imaging). This edge response with the movable attenuator having interior edges is, in a way, an abstraction of a multifocal concept paired with time encoding.

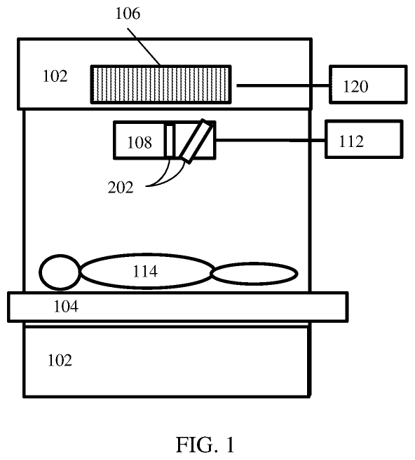

FIG. 1 shows one embodiment of an emission tomography system. The emission tomography system is a medical imager, such as a SPECT imaging system. The system is an imaging system for imaging a patient 114 on the bed 104. The emission tomography system uses edge response with a time-encoded aperture by moving the aperture with interior through-holes to increase sensitivity and sharpen resolution.

The emission tomography system includes a gantry 102, sensor 106, an attenuator 108, a drive 112, and an image processor 120. Additional, different, or fewer components may be provided. For example, a non-transitory memory is provided for storing detected emissions and/or instructions for execution by the processor 120. As another example, a display is provided for displaying a reconstructed image of the patient 114. In another example, a separate detection processor is provided for binning detected emissions.

The gantry 102 is part of a housing. The housing is metal, plastic, fiberglass, carbon (e.g., carbon fiber), and/or another material. The housing forms a patient region (e.g., bore) into which the patient is positioned for imaging. The bed 104 may move the patient within the patient region to scan different parts of the patient at different times. In other embodiments, a chair or bed without a housing forming a bore is used, such as where the sensor 106 and attenuator 108 are positioned by one or more robotic arms.

The gantry 102 is a motor, sensors, and/or track for moving the sensor 106 relative to the patient 114, such as moving to capture emissions from different angles and/or positions relative to the patient 114. In alternative embodiments, the bed 104 moves without having a gantry (e.g., the sensor 106 is fixed within the housing). In yet other alternatives, the sensor 106 and bed 104 are both fixed during imaging.

The sensor 106 is configured by structure and/or electronics to detect rays from emissions in the patient 114. The sensor 106 is configured to detect position, energy, and time of impact of gamma rays. The sensor 106 is a detector, such as a SPECT detector or gamma camera, without need for a collimator fixed relative to the sensor. Some of the rays pass through holes 202 in the interior of the attenuator 108 and/or along edges around the exterior of the attenuator 108. The sensor 106 detects the rays with the attenuator 108 at different known locations relative to the sensor 106. The different locations form a time-encoded aperture for the sensor 106.

In one embodiment, the sensor 106 is a SPECT sensor having a plurality of pixelated detector cells. For example, the sensor 106 is a gamma camera. The gamma camera includes one or more semiconductor sensors, such as pixelated sensors with detection cells. The sensor 106 is a made from room temperature semiconductor sensors. Another example is an array of silicon photon multiplier cells coupled to a scintillator. The sensor 106 forms an array of sensors or pixelated sensor cells. Anode and cathode electrodes are provided on opposite surfaces of the sensor 106. The electrodes have a same pitch as the detection cells and are electrically isolated from each other for separate electrical connections to the detection cells of the sensor 106.

Any material may be used, such as scintillators such as NaI, or direct converters such as CZT, CdTe, TlBr and/or another such material suitable for gamma ray imaging. The sensor 106 is created with wafer fabrication at any thickness, such as about 5-10 mm for CZT. The sensor 106 is square or has a rectangular shape for the emission detection face. Any size may be used, such as about 5×5 cm. Other shapes than rectangular or square may be used, such as triangular or hexagonal.

The sensor 106 is adjacent the patient region, such as mounted to the movable gantry 102. The sensor 106 is designed and configured to detect gamma emissions, such as emissions from the patient 114. The gamma camera may be a planar camera connected with the gantry 102 or housing to place the planar gamma camera at different locations relative to the source for detection of the emissions. For example, the gantry 102 moves the sensor 106 laterally or parallel with the bed 104 and/or rotates the sensor 106 around the longitudinal axis (i.e., around the bed 104). In other embodiments, a robotic arm or system is used to move the sensor 106. Alternatively, the sensor 106 is fixed to the housing 102 relative to the patient space.

The attenuator 108 is lead, tungsten, or another material that blocks, reflects, or absorbs gamma rays from emissions. The gamma rays are diverted or stopped so that the rays intersecting the attenuator 108 do not pass from the patient 114 to the sensor 106. The attenuator 108 is a ray-blocker.

The attenuator 108 is a plate or object with thickness to block the rays. Any shape may be provided for a largest surface, such as rectangular, hexagonal, or triangular. The shape forms exterior edges, such as sharp edges. The edges may be rounded or shaped depending on the amount of rotation and/or translation relative to the patient.

The attenuator 108 also includes one or more interior through-holes 202. Any number of through holes 202 may be provided, such as one, two, tens, or hundreds. The through-holes 202 form interior edges. The edges are sharp edges (e.g., flat) but may be rounded or have other shapes.

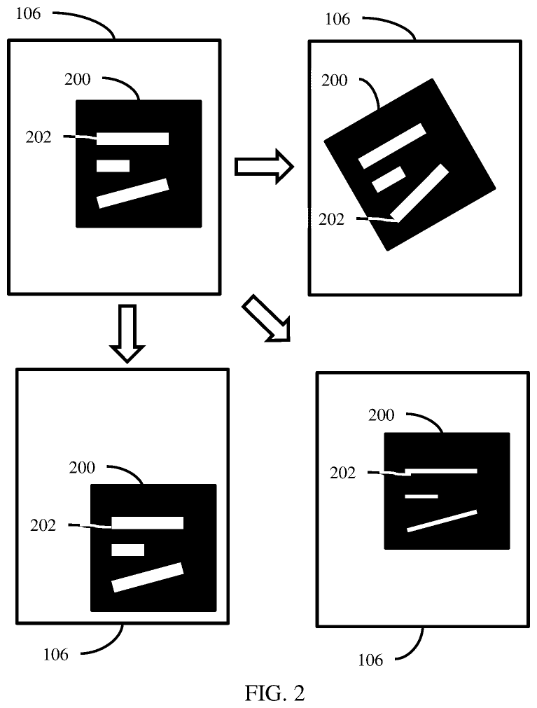

The through-holes 202 have any shape, size, and/or angle. FIG. 2 shows an example where the holes 202 are formed as slits. Circular, hexagonal, triangular, curved, and/or other shapes of holes 202 may be provided.

Rather than having holes sized to be at or lower than the resolution of the sensor 106, the holes are sized to include at least one dimension larger than the sensor 106 resolution. For example, a slit 202 may extend over tens or hundreds detector cells along at least one dimension or over two dimensions.

A hole 202 may have interior edges at right angles to the largest surface of the attenuator 108 (e.g., at a right angle to the sensor 106 where the largest surface is parallel with the detection face). The edges may be at other angles, such as to directionally block or allow emissions. FIG. 1 shows two holes 202 at two different angles (i.e., interior edges have different angles to the largest surface and/or detecting face of the sensor 106). Different parts of the edge formed for a given hole 202 have the same or different angles, such as having a trapezoidal shape in cross-section.

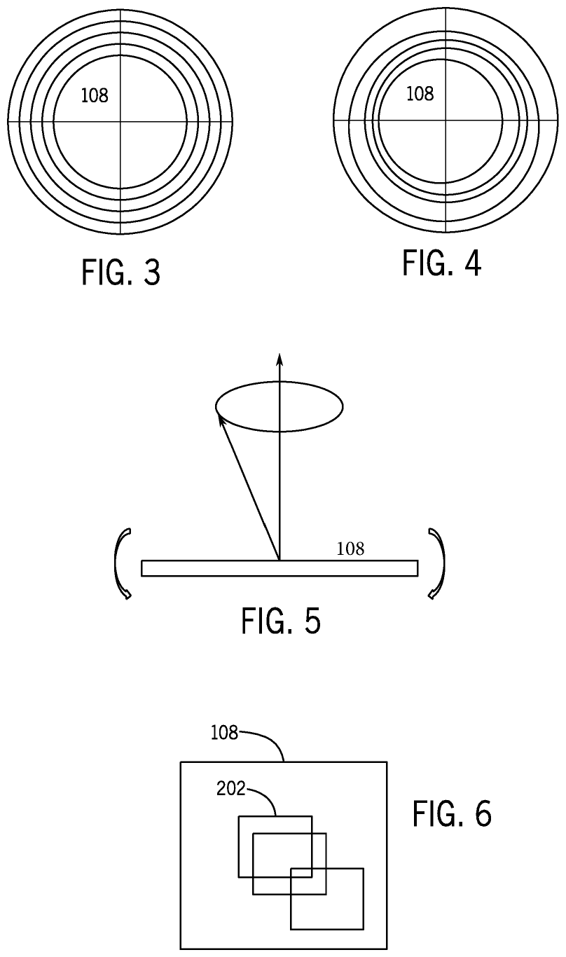

The holes 202 of the attenuator have the same or different shape, size, edge angle, and/or orientation. For example, all of the holes 202 have a same size, shape, edge angle, and orientation of the edges. As another example, different holes 202 have different sizes, shapes, orientations, and/or angles as at least one other hole 202. FIG. 2 shows three holes 202 each with a different size and/or shape. One hole 202 is angled within the face of the attenuator 108 relative to the other holes 202, providing a different orientation. FIG. 3 shows an example where the holes 202 are concentric rings or slits with different widths. FIG. 4 shows an example where the holes 202 are non-concentric rings or slits with different widths and different center locations on a largest face. FIG. 6 shows an example where the holes 202 are rectangular slits with the different holes 202 overlapping or intersecting. Different sizes, orientations, and/or thicknesses may be used.

By providing interior edges, more opportunity to delineate a direction from the source to the sensor 106 is provided. By providing different sizes, shapes, and/or angles, more information for delineation may be provided. Larger and/or more holes 202 results in collection of more emissions, increasing sensitivity.

In principle, any three-dimensional (3D) collimation may be used. Different shapes, sizes, edge angles, orientations, and/or combinations of holes 202 may provide for different processing (i.e., reconstruction) efficiency. For example, the holes 202 of the attenuator 108 of FIG. 6 may be an efficient pattern to map into rectangular form factors with the same aspect ratio as the sensor 106. Any 3D collimator shape can be created by stacking of 2D shapes. For example, a rectangular hole collimator can be created by plates with slits which are perpendicular to each other (“slit-slat”), and instead of moving the sensor with collimator to get different viewing angles one simply moves the “slit” in front of the “slat”, creating a moving pattern on the sensor's detection plane.

FIG. 8 shows another embodiment of the attenuator 108. The attenuator 108 is a hollow cylinder with slits for the holes 202. While shown as parallel slits of the same size and shape, holes of varying orientation, size, shape, or edge angles may be used. Other hollow shapes than cylinder may be used, such as a cuboid shape. The sensor 106 or source (e.g., patient 114) are positioned inside the cylindrical attenuator 108. The cylinder 108 may be rotated about the source or sensor 106 to provide movement relative to the sensor 106. With the sensor 106 inside the attenuator 108, ecto tomography with a small footprint may be provided, allowing the sensor 106 and attenuator 108 to be robotically moved around the patient or fixed relative to the patient without requiring a large housing and bore (i.e., the patient may sit in a chair or lay on their bed).

Referring again to FIG. 1, the drive 112 is a motor, such as a servo, electric motor, pneumatic compressor, actuator, hydraulic pump, or another motor for applying force to the attenuator 108. Gearing, pulleys, guides, clutch, rack and pinion, tubes, and/or other mechanisms transfer the force from the motor, such as rotational force from an electric motor to the attenuator 108. The drive 112 is configured by control and mechanical connection to move the movable attenuator 108. The drive 112 encodes the aperture, so is an encoding drive. The drive 112 positions the attenuator 108 in known positions and/or with a known movement. This encoding provides for positional relationship between the attenuator 108 and the sensor 106.

In one embodiment, the drive 112 is part of a robotic arm. The robotic arm positions and moves the attenuator 108. In other embodiments, the attenuator 108 connects with guides or gearing to repetitively move in a controlled manner. The drive 112 is configured to move the attenuator 108 with the interior edges from the holes 202 and possibly the exterior edges between the sensor 106 and the patient 114 (i.e., emitting object).

The drive 112 moves the attenuator 108 with any degree of freedom, such as one to six degrees of freedom. In one embodiment, the movement is in three dimensions, such as three rotational degrees of freedom, three translational degrees of freedom, or any three degrees of rotational and translational degrees of freedom.

FIG. 2 shows some examples. The shadow 200 of the attenuator 108 on the sensor 106 is shown. Three holes 202 and the exterior edges result in the shadow 200 on the sensor 106 in this example. Where the attenuator 108 is larger than the sensor 106, then the shadow would include the holes 202 (i.e., interior edges) and not all of or any of the exterior edges.

The upper left figure shows the shadow 200 where the largest surface of the attenuator 108 is parallel with the sensor face of the sensor 106 (i.e., normal for both are parallel with each other and perpendicular to the page). The attenuator 108 may be rotated about the normal centered on the attenuator 108 or offset at another location. The upper right shows rotation or change in orientation about a center of the attenuator 108 and shadow 200 and a slight translation to the left. The lower left shows the shadow 200 translated to a different position along a vertical dimension and slightly along a horizontal dimension. The lower right shows the shadow 200 from tilting of the attenuator 108 about an horizontal axis on the page so that one edge is closer to the sensor 106 than an opposite edge. The result of this tilting about the horizontal axis is that the shadow 200 includes narrower slits from the holes 202 as viewed from a normal to the sensor face. Other motions or combinations of motions may be provided.

FIG. 8 shows rotational motion of the cylinder formed by the attenuator 108. The drive 112 rotates the attenuator 108 about a center axis or an offset axis to cause the shadow from the holes 202 to move relative to the sensor 106. The sensor 106 may also be moved, such as translation along the axis of the cylinder and/or tilting about a perpendicular axis to the axis of the cylinder.

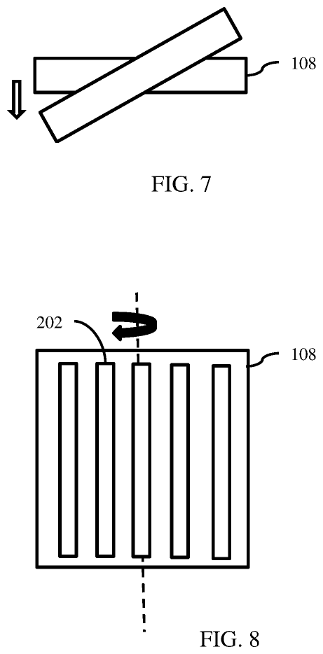

FIG. 7 shows tilting motion of the attenuator 108. For a cosine alpha effect, the attenuator 108 with the holes 202 is tilted. The attenuator 108 is rotated about a center axis parallel to the largest surface of the attenuator. Other axes of rotation may be used. The attenuator 108 may be rotated, providing a rocking motion. The attenuator 108 may be cyclically rotated in opposite directions to further rock.

FIG. 5 shows wobbling the attenuator 108. The attenuator 108 is wobbled around a normal to the attenuator 108. The wobble may be along other axes, either parallel or not parallel to the normal. The attenuator 108, as a plate with holes 202, is wobbled so that the normal vector precesses with some opening angle and frequency ω.

Other motions and/or combinations of motions may be provided. The motion is with any frequency, speed, and/or range. Variation in the motion may be provided, such as changing the speed, frequency, or range. The motion may be continuous or may operate as a step function. For example, the attenuator 108 is held at a given position for a period, such as 5 minutes, and then moved to another position, at which the attenuator 108 is held for the same or different period. Any number of steps or discrete hold positions may be used, such as two, tens, or hundreds. Any hold time may be used, such as seconds or minutes. The motion is used to create a strong locally varying pattern that probes spatial frequencies.

The image processor 120 of FIG. 1 is a general processor, artificial intelligence processor or accelerator, tensor processor, digital signal processor, graphics processing unit, application specific integrated circuit, field programmable gate array, digital circuit, analog circuit, combinations thereof, or another now known or later developed device for processing emission information and/or reconstructing an image based on detected emissions (e.g., locations, energies, and/or times of incident radiation). The image processor 120 is a single device, a plurality of devices, or a network. For more than one device, parallel or sequential division of processing may be used. Different devices making up the image processor 120 may perform different functions, such as one processor for controlling movement of the attenuator 108 and another processor for forming projections from detected emissions (i.e., locations, energies, and/or times) and the time-encoded aperture and for reconstructing from the projections. In one embodiment, the image processor 120 is a control processor or other processor of the medical imaging system. In other embodiments, the image processor 120 is part of a separate workstation, server, or computer.

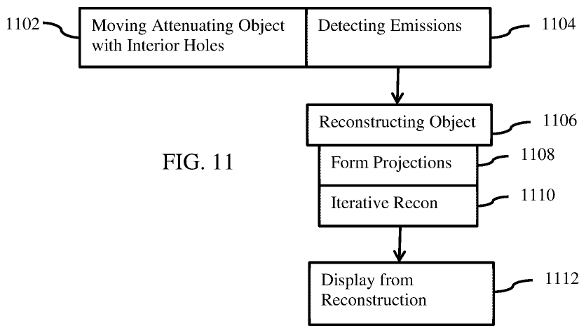

The image processor 120 operates pursuant to stored instructions to perform various acts described herein, such as acts 1106, 1108, and/or 1110 of the method of FIG. 11. The image processor 120 is configured by software, firmware, and/or hardware to perform the acts.

The image processor 120 is configured to reconstruct an object from detected emissions. The location, time, and energy of the emissions are used to reconstruct the object. The spatial distribution of the sources of the emissions, such as a radiopharmaceutical within the patient 114, is reconstructed. The image processor 120 reconstructs the spatial distribution of the sources of emissions detected by the sensor 106 with the movable attenuator 108 in different positions due to movement by the drive 112.

Since the attenuator 108 causes local patterns (i.e., shadows 200) at different times due to movement between the source of the emissions and the sensor 106, this time-encoded aperture is used to determine the directionality in the reconstruction. The moving shadow 200 of the holes 202 cast on the sensor 106 is used in the reconstruction.

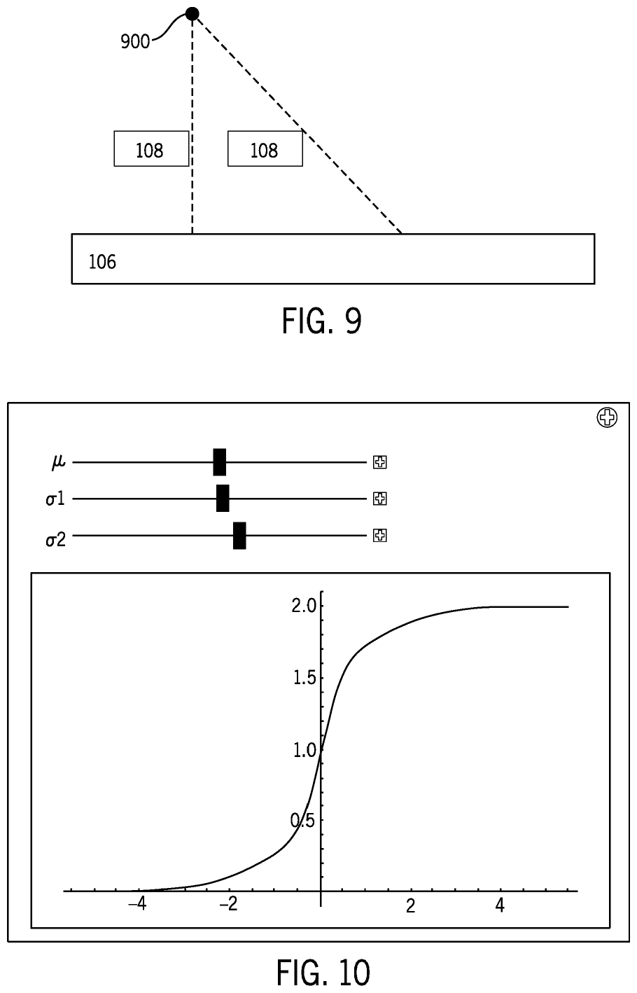

FIG. 9 shows an example based on the exterior edge of the attenuator 108. The same principle applies for interior edges. By having multiple edges, more information may be obtained for a given position of the attenuator 108 relative to the sensor 106.

A source 900 emits at different times. The attenuator 108 is at different locations relative to the sensor 106 at those different times. Due to the different position of the attenuator 108, the location of the source 900 may be resolved based on the location of the edge of the attenuator 108 and the location of detection on the sensor 106. Triangulation and the time-encoded aperture provides for the location of the source 900 in three dimensions. The shadow determined by the shape and moment of the attenuator 108 (assuming a rigid body or known variation of a non-rigid body) indicates directionality.

The known position of detection by the sensor 106 and position of attenuator 108 allows for triangulation. If the position of the attenuator 108 is not known but the shape and movement is known, the set of shadows 200 are enough to determine position of the source 900. Since many emissions from various sources occur, tomography is used rather than attempting to resolve each source individually. Statistics can bound an optimization to tomographically reconstruct the sources 900. The optimization includes the aforementioned ancillary conditions and solves for a maximum information question (MIQ) where directionality is extracted from the nonlocal pattern of the PSF across the field of view encoded time varying aperture pattern based on the semi-positive definite detected event data.

The image processor 120 is configured to reconstruct. The detected emissions have time and location. Energy information may be included, such as to filter the emissions to a specific energy or energy range. An optimization is applied to minimize a difference between the detected emissions and a distribution of sources that would result in the emissions. The optimization includes forward and back projection between the emission or sensor space and the object or image space. The projections include a system model. The system model includes the time-encoded aperture (e.g., position and orientation of the attenuator 108 relative to the sensor 106). The physics of the local pattern (shadow 200) may be part of the system model. The point spread function determined due to the time-encoded aperture may be used in the reconstruction. By iteratively optimizing, the difference is minimized until a reconstruction by pixel or voxel of the object results. Various optimizations may be used, such as different optimizations used for SPECT.

The reconstruction may be performed in other ways. In one embodiment, the image processor 120 forms virtual projections from different views. The representation of the patient 114 (i.e., distribution of sources in the patient 114) is reconstructed from the virtual projections. The virtual projections are formed from emissions detected by the sensor 106 using the time-encoded aperture. The emission data is rebinned, resampled, and/or collected for different angles or views to form the projections. Projections are formed from the emissions, and the reconstruction of the spatial distribution is from the projections.

A virtual PSF is restored by measuring the edge response (shadow 200) of the attenuator 108 on the sensor 106. The time encoding is extended form just small movements in front of the sensor 106 to any movement of a multitude of apertures (holes 202 of one or more shapes and/or sizes), which movement creates different patterns on the sensor 106 at each stationery view. For instance, a plate with slits can tilt, rotate, and/or shift in front of sensor 106, creating k distinct patterns. As the motion is known, and it is also known that the patient 114 for the dwell time has not changed (quasi stationary, with sampling time determined by needed contrast, noise, etc.), a virtual PSF is constructed. The virtual PSF imitates a non-local better resolved PSF. The virtual PSF relies on the inversion of: ½ (Sqrt[1∧[Sigma]1\hat{ }2]\[Sigma]1+Sqrt[1∧[Sigma]2\hat{ }2]\[Sigma]2+Erf[(y−\[Mu])/(Sqrt[2]\[Sigma]1)]+ERF[(y−\[Mu])/(Sqrt[2]\[Sigma]2)]). where sigma 1 and 2 define a Gaussian curve, ERF is the error function based on integrating the Gaussian, and mu is linear attenuation coefficient. FIG. 10 shows an example plot of the virtual PSF. The PSF models the sharp edge to determine the directionality.

In one embodiment, the projections are formed as virtual parallel hole collimator projections. The detected emissions and time-encoded aperture are used to determine a projection with common directionality for each of different views relative to the patient 114. As a result of adding convolved PSF's (Gaussian with sigma1, sigma2 in the example of FIG. 10) of the Heaviside function, the quasi-planar projection of a regular parallel hole collimator at a viewing angle is restored. The same is repeated at a different viewing angles until the tomography conditions of Orlov, Tuy, and Nyquist are fulfilled. A projection view set as if resulting from a very highly resolving collimator, yet with apertures much bigger, is restored. The resolution may be greater since directionality is based on edge response. Since the apertures (holes 202) are larger than a parallel hole collimator, greater sensitivity is provided. Other tomographically suitable projections than parallel hole collimator projections may be formed. The viewing angle requirements may be relaxed while still fulfilling the tomographic conditions.

The image processor 120 uses the projections for iterative reconstruction. For example, the virtual parallel hole collimator projections are reconstructed using forward and back projection. Any now known or later developed emission tomography or SPECT reconstruction may be used to reconstruct from the projections. The projections represent directional counts from the gamma camera as provided as if a collimator were used. SPECT iterative reconstruction is performed using the virtual PSF.

This embodiment of reconstruction uses a 2-step process. First, virtual projections (e.g., a virtual parallel hole collimator projection image) are restored. Second, reconstruction is performed on the virtual projections. For the first step, the created local pattern can be restored to virtual non-local image formation. Artificial intelligence (AI) (e.g., a machine-learned model such as a deep learned model) may be used to form the projections from the emission data. The time-encoded aperture may be used as an input with the emission data to the AI or the AI may be trained for a known time-encoded aperture, so the emission data alone is input. The AI outputs the projection or projections. Choquet integrals may be used to model the complex decision making process of the observer, and thereby optimizing the image formation design.

FIG. 11 shows one embodiment of a flow chart of a method for emission tomography (e.g., SPECT). By moving an attenuator and/or sensor relative to each other, a time-encoded aperture is formed. By including holes in the attenuator, more information is provided for edge response measurements. Since direction is less limited, the reconstruction uses a staged approach where virtual projections are formed, and then the object or image is reconstructed from the virtual projections. In another reconstruction approach, optimization using the time-encoded aperture as part of the system model may be used.

The method is implemented by an emission tomography imager or system, such as a SPECT system. A motor moves an attenuator, and a sensor detects emissions with the attenuator in different locations relative to the sensor. An image processor reconstructs from the detected emissions and time-encoded aperture (e.g., patterns from the shadow of the attenuator). The image processor generates an image of the reconstructed object, which image is shown by a display device or screen. Other components may be used to perform and/or to aid in any of the acts.

The acts are performed in the order shown (i.e., top-to-bottom or numerically) or another order. Acts 1102 and 1104 are performed iteratively, such as moving the attenuator, then detecting, then moving, the detecting, and so on for any number of cycles. Act 1104 may be performed first, and then the attenuator moved in act 1102, or vise versa.

Additional, different, or fewer acts may be provided. For example, acts for moving the sensor, positioning the patient, and/or three-dimensional rendering from a reconstructed volume distribution may be included. As another example, the display act 1112 is not performed, such as where the image or reconstruction is stored or transferred for storage in a radiology report, electronic patient medical record, or picture archiving and communications system (PACS).

In act 1102, the attenuating object (e.g., attenuator or ray-blocker) is moved. The attenuating object has interior edges. The object is moved between the patient and the sensor. The interior edges with or without the exterior edges form a time-encoded aperture on the sensor due to the movement. The pattern or shadow from the attenuating object is shifted two or more times, providing a time-encoded aperture. The movement causes the interior edges from holes and any exterior edges to have different position, shapes, sizes, orientation, and/or angles (see FIG. 2).

The motion is a rotation and/or translation along one or more (e.g., three) dimensions. Moving by translation or rotation in three dimensions allows for greater variety in the shadow. Moving with both rotation and translation about the three dimensions creates an even greater variety. Where one or more holes may be shifted or altered, then additional variety in the shadow is provided. Also moving the sensor may contribute further variety. The shape and/or size of the holes in the shadows on the sensor are different at different times

The movement may be by translation and/or rotation in a plane parallel to the detection face of the sensor. The movement may be a translation, tilt, or wobble out of this plane. In another embodiment, the movement is a rotation of the attenuating object about the sensor.

In act 1104, the sensor detects emissions from the patient. Some emissions pass the sensor. Other emissions are blocked by the attenuator. Other emissions pass by the attenuator, such as past the exterior or through holes, to the sensor. The attenuator casts a shadow based on emissions on the sensor.

The detection is performed with the attenuator in a given position. Detection is then performed with the attenuator in a different position. Any period for detection may be used. The energy, time, and location on the sensor of each detected emission is used to identify detection events. Counts at different locations on the sensor are performed for a given attenuator position as many emissions occur.

Since the detected emissions are only the incident rays passing by the attenuator, different shadows result from the attenuator at different positions. The detected events reflect these shadows, allowing for edge response. Due to the interior edges, a greater number of events are detected, and more edges are provided to determining directionality due to edge response. The time-encoded aperture and corresponding detected events for each position of the aperture formed by the attenuator are recorded. The movement of the attenuating object results in different shadows on the sensor based on detection by the sensor. The orientation and/or location of the attenuating object relative to the sensor is different at different times due to the movement of act 1102.

In act 1106, the image processor reconstructs a representation of the patient from the detected emissions using the time-encoded aperture. The edge response of the shadows is used to determine or limit directionality in the optimization. The edges limit the angles to a range of angles. By having the edges at different positions relative to the sensor at different times, the edge response indicates the location of the source based on the detected location on the sensor. The representation is reconstructed from the edge response of the shadows of the attenuating object on the sensor.

In one embodiment, optimization is used where the shadows or time-encoded aperture are part of the system model. The detected events from different times and the time-encoded aperture are used to solve for the spatial distribution of sources in the patient.

In another embodiment, a two-stage approach represented by acts 1108 and 1110 is used. In act 1108, projections at different viewing angles relative to the patient are constructed. The projections are constructed from the detected emissions and based on the time-encoded aperture. For example, virtual PSFs are created by integration using a Gaussian model. The virtual PSFs from the different directions are determined by the ray tracing and careful recording of signal changes, with the known condition of non-negativity. In act 1110, the projections are used as samples or binned counts from the sensor at different views. Iterative optimization is performed with the projections as inputs. The iterative optimization solves for the spatial distribution of the sources from the projections from emissions from those sources.

In act 1112, an image is generated from the reconstruction. The spatial distribution represents the distribution of the sources in a plane or a volume. The representation is reformatted to display as an image of a two-dimensional display. For a two-dimensional representation, the reformatting scan converts to the resolution and/or dynamic range of the display. For a three-dimensional representation, the voxels are rendered to a two-dimensional image, such as using volume or surface rendering.

The resulting image is displayed on a display screen. A physician may view the locations and/or intensity of the uptake of the radiopharmaceutical by tissue of the patient. The hot spots or locations represent function of the tissue, allowing the physician to identify poor function or areas of concern for diagnosis and/or treatment.

Instead of using a sensor with a fixed collimator, which combination may be moved to detect from different angles, relative motion and even change of pattern of the attenuator relative to the sensor is provided. The attenuator casts a shadow on the sensor. Since the attenuator moves (e.g., translates, rotates, and/or deforms) in a known way, the shadow of the attenuator on the sensor changes, creating a varying shadow pattern on the sensor. By including multiple holes and/or edges of different known sizes, shapes, and angles, many emissions pass the attenuator with additional information resulting from the edges. The emission pattern may be deduced by looking from difference directions towards the source and also gathering information from the different shadows. More signal and resulting information are used with the known aperture encoding to solve for the distribution of emitters in the source (patient). Instead of looking through a collimator only seeing what is in front and rotating the sensor and collimator together to capture more viewing angles, the sensor may stay still to capture information due to the movement of the attenuator.

While the invention has been described above by reference to various embodiments, many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. An emission tomography system comprising:
a sensor having configured to detect position, energy and time of impact of gamma rays;
a movable attenuator having one or more interior through-holes, the moveable attenuator moveable relative to the sensor;
a drive configured to move the movable attenuator; and
an image processor configured to reconstruct a spatial distribution of emissions detected by the sensor with the movable attenuator in different positions due to movement by the drive, the movable attenuator between a source of the emissions and the sensor such that a moving shadow of the through-holes is cast on the sensor.

2. The emission tomography system of claim 1 wherein the sensor comprises a planar gamma camera.

3. The emission tomography system of claim 2 wherein the planar gamma camera connects with a gantry configured to place the planar gamma camera at different locations relative to the source for detection of the emissions.

4. The emission tomography system of claim 1 wherein the movable attenuator comprises a lead or tungsten object.

5. The emission tomography system of claim 1 wherein the movable attenuator is movable by translation and/or rotation in three dimensions.

6. The emission tomography system of claim 1 wherein the through-holes comprise slits.

7. The emission tomography system of claim 1 wherein the through-holes comprise different size, shapes, and/or angles of holes.

8. The emission tomography system of claim 1 wherein the movable attenuator comprises a rotatable cylinder where the source or sensor is positionable within the rotatable cylinder, the drive configured to rotate the rotatable cylinder.

9. The emission tomography system of claim 1 wherein the drive is configured to rock the movable attenuator.

10. The emission tomography system of claim 1 wherein the drive is configured to wobble the movable attenuator around a normal to the movable attenuator.

11. The emission tomography system of claim 1 wherein the image processor is configured to form projections from the emissions and the reconstruction of the spatial distribution is from the projections.

12. The emission tomography system of claim 11 wherein the projections are virtual parallel hole collimator projections and wherein the reconstruction is an iterative reconstruction with the virtual parallel hole collimator projections in forward and back projection.

13. A method for single photon emission computed tomography (SPECT), the method comprising:
moving an attenuating object with interior edges between a patient and a sensor, the interior edges with the moving forming a time-encoded aperture on the sensor;
detecting, by the sensor, emissions from the patient passing through the attenuating object with different shadows on the sensor due to the time-encoded aperture; and
reconstructing a representation of the patient from the detected emissions using the time-encoded aperture.

14. The method of claim 13 wherein moving the attenuating object comprises rotating and/or translating in three dimensions, and wherein detecting comprises detecting with the shadows being different due to location on the sensor and/or rotation of the attenuating object.

15. The method of claim 13 wherein moving the attenuating object comprises moving where the interior edges form holes having different shapes, sizes, and/or angles.

16. The method of claim 13 wherein holes in the attenuating object form the edges, and wherein moving comprises moving in three dimensions so that a shape and/or size of holes in the shadows is different at different times.

17. The method of claim 13 wherein reconstructing comprises restoring a virtual point spread function from edge response of the shadows.

18. The method of claim 13 wherein reconstructing comprises constructing projections at different viewing angles relative to the patient from the detected emissions and based on the time-encoded aperture, and reconstructing from the projections.

19. An emission tomography system comprising:
a ray-blocker with interior edges forming holes through the ray-blocker;
a sensor configured to detect rays passing through the holes with the ray-blocker at different locations relative to the sensor, the different locations forming a time-encoded aperture for the sensor; and
an image processor configured to form virtual projections from different view from emissions detected by the sensor using the time-encoded aperture and to reconstruct a representation of a patient from the virtual projections.

20. The emission tomography system of claim 19 wherein the holes have different sizes, shapes, and/or angles.
